(19) United States
(12) Patent Application Publication
(10) Pub. No.: US 2026/0341687 A1
(43) Pub. Date: Oct. 29, 2026

(54) POSITIVE ELECTRODE MIXTURE, METHOD FOR MANUFACTURING POSITIVE ELECTRODE MIXTURE, AND LITHIUM ION BATTERY

(71) Applicant: IDEMITSU KOSAN CO.,LTD., Chiyoda-ku, Tokyo (JP)

(72) Inventors: Yamato HANIU, Chiyoda-ku, Tokyo (JP); Hiroyuki HIGUCHI, Chiyoda-ku, Tokyo (JP); Yu ISHIHARA, Chiyoda-ku, Tokyo (JP); Yuta FUJII, Chiyoda-ku, Tokyo (JP)

(73) Assignee: IDEMITSU KOSAN CO.,LTD., Chiyoda-ku, Tokyo (JP)

(21) Appl. No.: 19/102,496

(22) PCT Filed: Aug. 2, 2023
(86) PCT No.: PCT/JP2023/028345

§ 371 Date: Feb. 10, 2025

(30) Foreign Application Priority Data
Aug. 10, 2022 (JP) 2022-127908

(51) Int. Cl. H01M 4/38; H01M 4/02; H01M 4/04; H01M 4/62; H01M 10/0525

(52) U.S. Cl. CPC H01M 4/38; H01M 4/0471; H01M 4/625; H01M 10/0525; H01M 2004/021; H01M 2004/028

(57) ABSTRACT

A positive electrode mixture including a sulfur-based active material and a solid electrolyte, wherein in the powder X-ray diffraction using CuKα ray, the positive electrode mixture has a diffraction peak A at 2θ=25.6±0.5° and a diffraction peak B at 2θ=45.2±1.0°, and it has a half width of the diffraction peak A of 0.25° or larger.

### TECHNICAL FIELD

The present invention relates to a positive electrode mixture, a method for producing a positive electrode mixture, and a lithium-ion battery.

Specifically, the present invention relates to a positive electrode mixture capable of decreasing the ionic resistance, a method for producing a positive electrode mixture, and a lithium-ion battery.

### BACKGROUND ART

When sulfur is combined with a conductive aid and a solid electrolyte in a sulfur-based positive electrode mixture used for a lithium-ion battery or the like, a reaction of sulfur which is insulative can sufficiently occur (Patent Documents 1 to 3).

### RELATED ART DOCUMENTS

### Patent Documents

[Patent Document 1] JP 2014-011033 A
[Patent Document 2] JP 2020-161288 A
[Patent Document 3] WO 2022/080435 A1

### SUMMARY OF THE INVENTION

However, in the related art including Patent Documents 1 to 3, there is room for further improvement from the viewpoint of decreasing the ionic resistance of a positive electrode mixture.

An object of the present invention is to provide a positive electrode mixture capable of decreasing the ionic resistance, a method for producing a positive electrode mixture, and a lithium-ion battery.

As a result of intensive studies, the inventors have found that a positive electrode mixture satisfying the specific conditions can decrease the ionic resistance, and have completed the present invention.

According to the present invention, the following positive electrode mixture and the like can be provided.
1. A positive electrode mixture comprising a sulfur-based active material and a solid electrolyte,
   wherein in the powder X-ray diffraction using CuKα ray, the positive electrode mixture has a diffraction peak A at 2θ=25.6±0.5° and a diffraction peak B at 2θ=45.2±1.0°, and
   it has a half width of the diffraction peak A of 0.25° or larger.
2. The positive electrode mixture according to 1, wherein a left-right asymmetry parameter E′ of the diffraction peak B is 1.50×10⁴ or more.
3. The positive electrode mixture according to 1 or 2, which further comprises a conductive aid.
4. The positive electrode mixture according to 3, wherein the conductive aid has a pore having a pore diameter of smaller than 5 nm.
5. The positive electrode mixture according to 3 or 4, wherein the conductive aid comprises one or more members selected from the group consisting of activated carbon and carbon black.
6. The positive electrode mixture according to any one of 1 to 5, which is obtained by heating treatment of a positive electrode mixture precursor obtained by mechanically mixing the sulfur-based active material and a solid electrolyte having the diffraction peak A at 2θ=25.6±0.5° and having the diffraction peak B at 2θ=45.2±1.0° in powder X-ray diffraction using CuKα ray.
7. The positive electrode mixture according to 6, wherein a temperature of the heating treatment is 160 to 280 °C.
8. A method for producing a positive electrode mixture, comprising: mechanically mixing a sulfur-based active material and a solid electrolyte having a diffraction peak A at 2θ=25.6±0.5° and having a diffraction peak B at 2θ=45.2±1.0° in powder X-ray diffraction using CuKα ray to obtain a positive electrode mixture precursor, and
   heating the positive electrode mixture precursor to obtain a positive electrode mixture,
   wherein the heating temperature is 160 to 280 °C.
9. A lithium-ion battery comprising the positive electrode mixture according to any one of 1 to 7.

According to the present invention, there can be provided a positive electrode mixture capable of decreasing the ionic resistance, a method for producing a positive electrode mixture, and a lithium-ion battery.

### BRIEF DESCRIPTION OF THE DRAWINGS

FIG. 1 is a diagram showing the results of powder X-ray diffraction (XRD).

FIG. 2 is an enlarged view of the high-angle-side of XRD of FIG. 1.

FIG. 3 is a diagram showing the result of XRD of Example 3.

### MODE FOR CARRYING OUT THE INVENTION

Hereinafter, the positive electrode mixture, the method for producing a positive electrode mixture, and the lithium-ion battery of the present invention will be described in detail.

In this specification, “x to y” represents a numerical range of “x or more and y or less”. An upper limit value and a lower limit value described for the numerical range may be arbitrarily combined.

### 1. Positive Electrode Mixture

A positive electrode mixture according to an aspect of the present invention includes a sulfur-based active material and a solid electrolyte, wherein in the powder X-ray diffraction using CuKα ray, the positive electrode mixture has a diffraction peak A at 2θ=25.6±0.5° and a diffraction peak B at 2θ=45.2±1.0°, and it has a half width of the diffraction peak A of 0.25° or larger.

According to the positive electrode mixture of the present aspect, an effect of decreasing the ionic resistance thereof can be achieved.

The positive electrode mixture as the present aspect cannot be produced by the conventional art.

That is, when a method in which the solid electrolyte is added to a composite of sulfur and carbon and then they are mechanically mixed with strong energy is used, the crystallinity of the solid electrolyte is lowered by the mechanical mixing, and Li⁺ conductivity is lowered to increase the ionic resistance thereof.

In contrast, when they are mechanical mixed and then the heating treatment is conducted at the specific temperature (which will be described in detail later), the solid electrolyte can obtain a characteristic crystallinity which contributes the decrease of the ionic resistance thereof. A new crystalline phase having a slightly different lattice constant is generated in addition to the original crystalline phase, and as a result, such crystallinity can be obtained. When these crystalline phases are present, the half width of the diffraction peak A is 0.25° or larger, and the left-right asymmetry parameter ε′ of the diffraction peak B, which will be described later, is preferably 1.50×10⁴ or more.

Powder X-ray diffraction using CuKα ray is conducted using the method described in Examples.

The half width of the diffraction peak A is a value obtained by subtracting the apparatus constant, and it is specifically calculated using the method described in Examples.

In one embodiment, the half width of the diffraction peak A is 0.25° or larger, 0.26° or larger, 0.27° or larger, 0.28° or larger, 0.29° or larger, 0.30° or larger, 0.31° or larger, or 0.32° or larger. The upper limit thereof is not particularly limited, and it is, for example, 2.0° or smaller.

In one embodiment, the left-right asymmetry parameter s′ of the diffraction peak B is 1.50×10⁴ or more. As a result, the effect of the present invention is more remarkably exhibited.

The left-right asymmetry parameter ε′ of the diffraction peak B is calculated using the method described in Examples.

In one embodiment, the left-right asymmetry parameter s′ of the diffraction peak B is 1.50×10⁴ or more, 2.00×10⁴ or more, 3.00×10⁴ or more, 4.00×10⁴ or more, or 5.00×10⁴ or more. The upper limit thereof is not particularly limited, and it is, for example, 5.00×10⁵ or less.

The sulfur-based active material is not particularly limited, but examples thereof include sulfur, lithium sulfide (Li₂S), lithium polysulfide (Li₂Sₙ: n satisfies 1≤n≤8), titanium sulfide (TiS₂), molybdenum sulfide (MoS₂), iron sulfide (FeS, FeS₂), copper sulfide (CuS), nickel sulfide (Ni₃S₂), sulfur-containing polymer compound, and the like.

The sulfur is not particularly limited, but it is preferably high in purity. Specifically, the purity thereof is preferably 95% by mass or higher, more preferably 96% by mass or higher, and particularly preferably 97% by mass or higher.

Examples of the crystal system of the sulfur include α-sulfur (orthorhombic system), β-sulfur (monoclinic system), γ-sulfur (monoclinic system), amorphous sulfur, and the like. These may be used alone, or two or more thereof may be used in combination.

The positive electrode mixture may include a solid electrolyte having the diffraction peak A at 2θ=25.6±0.5° and the diffraction peak B at 2θ=45.2±1.0° in powder X-ray diffraction using CuKα ray as the solid electrolyte.

Examples of the solid electrolyte include a solid electrolyte containing an argyrodite type crystalline structure. Examples of argyrodite type crystalline structure include a Li₇PS₆ crystalline structure; crystalline structures represented by compositional formulas represented by Li₇₋ₓP_{1-y}Si_{y}S₆ and Li₇₊ₓP_{1-y}Si_{y}S₆ (x is −0.6 to 0.6, y is 0.1 to 0.6) having a Li₇PS₆ structural skeleton; a crystalline structure represented by Li_{7-x-2y}PS_{6-x-y}Clₓ (0.8≤x≤1.7, 0<y≤−0.25x+0.5); and a crystalline structure represented by Li₇₋ₓPS₆₋ₓHaₓ (Ha is Cl or Br, and x is preferably 0.2 to 1.8).

However, the solid electrolyte containing the above-described argyrodite type crystalline structure alone as the crystalline structure and a positive electrode mixture including the solid electrolyte and obtained by mechanically mixing it do not satisfy the condition that the half width of the diffraction peak A is 0.25° or larger, nor the condition that the left-right asymmetry parameter ε′ of the diffraction peak B is 1.50×10⁴ or more. As described above, it is mechanical mixed, and then heating treatment is conducted at the specific temperature to generate a new crystalline phase at a slightly different position in addition to the original crystalline phase. As a result, these conditions are satisfied.

### (Conductive Aid)

In one embodiment, the positive electrode mixture further includes a conductive aid.

In one embodiment, the conductive aid is a carbon material.

The conductive aid being the carbon material may be a material having electronic conductivity. The conductive aid preferably has a plurality of pores. It is particularly preferably a carbon material having pores. The carbon material is highly conductive and lighter than other conductive materials so that the power density per weight of the battery can be increased.

The specific surface area of the conductive aid is preferably 0.1 m²/g or more and 5,000 m²/g or less, more preferably 1 m²/g or more and 4,000 m²/g or less, still more preferably 1 m²/g or more and 3,000 m²/g or less, and most preferably 10 m²/g or more and 3,000 m²/g or less.

The pore volume of the conductive aid is preferably 0.1 cc/g or more and 5.0 cc/g or less.

The pores of the conductive aid preferably have an average diameter of 0.1 nm or more and 40 nm or less, more preferably 0.5 nm or more and 40 nm or less, still more preferably 0.5 nm or more and 20 nm or less, and most preferably 1 nm or more and 20 nm or less.

The specific surface area of the conductive aid, the pore volume thereof, and the pore diameter thereof can be obtained by using a nitrogen adsorption isotherm obtained by adsorbing nitrogen gas to the conductive aid at the liquid nitrogen temperature. Specifically, the specific surface area thereof can be calculated by Brenauer-Emmet-Telle (BET) multi-point method using the nitrogen adsorption isotherm. The pore volume thereof and the pore diameter thereof can be obtained by Barret-Joyner-Halenda (BJH) method using the nitrogen adsorption isotherm.

As the measuring device, for example, it can be measured using a specific surface area and pore distribution measuring device (Autosorb-3) manufactured by Quantacrome.

The carbon material is not limited, but examples thereof include carbon black such as Ketjen black, acetylene black, Denca black, thermal black and channel black, mesoporous carbon, activated carbon, amorphous carbon, carbon nanotube, vapor grown carbon fiber (VGCF), carbon nanohorn, fullerene, carbon fiber, natural graphite, artificial graphite, graphene, graphene oxide, reduced graphene oxide, and the like. These may be used alone, or two or more of them may be used in combination. Also, a composite of them can be used.

A mesoporous carbon is a carbon material having pores in two dimensions or three dimensions obtained by the process described in the following documents: for example, S. J. Sang, S. H. Joo, R. Ryoo, et., J. Am. Chem. Soc., 122 (2000) 10712-10713, and T. Yokoi, Y. Sakamoto, O. Terasaki, et., J. Am. Chem. Soc., 128 (2006) 13664-13665.

In one embodiment, the conductive aid has pores having a pore diameter of smaller than 5 nm.

In one embodiment, the conductive aid does not have a pore having a pore diameter of 5 nm or larger.

The pore diameter is a value measured by a nitrogen adsorption-desorption measurement method.

In one embodiment, the conductive aid includes one or more members selected from the group consisting of activated carbon and carbon black.

In one embodiment, the conductive aid does not contain “a carbon replica having a three-dimensional honeycomb structure (closed cell structure) and having a pore having a pore diameter of 5 nm or larger and 20 nm or smaller”.

In one embodiment, the positive electrode mixture may or may not include other component other than the sulfur-based active material, the solid electrolyte and the conductive aid.

The other component is not particularly limited, and examples thereof include a binder, a solvent, a dispersant, and the like.

The amounts of the sulfur-based active material, the solid electrolyte and the conductive aid is not particularly limited in the positive electrode mixture.

In one embodiment, the amount of the sulfur-based active material is 40 to 350 parts by mass based on 100 parts by mass of the solid electrolyte.

When the positive electrode mixture includes the conductive aid, the mass ratio of the sulfur-based active material to the conductive aid (sulfur-based active material: conductive aid) is 10:90 to 95:5, and preferably 30 to 70:90 to 10.

In one embodiment, 50% by mass or more, 60% by mass or more, 70% by mass or more, 80% by mass or more, 90% by mass or more, 95% by mass or more, 99% by mass or more, 99.5% by mass or more, or substantially 100% by mass of the positive electrode mixture is the sulfur-based active material and the solid electrolyte, or the sulfur-based active material, the solid electrolyte and the conductive aid. When “substantially 100% by mass” thereof is formed of those materials, it may contain an inevitable impurity.

In one embodiment, the positive electrode mixture is obtained by heating treatment of a positive electrode mixture precursor obtained by mechanically mixing the sulfur-based active material and a solid electrolyte having the diffraction peak A at 2θ=25.6±0.5° and having the diffraction peak B at 2θ=45.2±1.0° in powder X-ray diffraction using CuKα ray.

In one embodiment, a temperature of the heating treatment is 160 to 280 °C.

The description given for a method for producing a positive electrode mixture according to an aspect of the present invention described below is used for these embodiments.

### 2. Method for Producing Positive Electrode Mixture

A method for producing a positive electrode mixture according to an aspect of the present invention including: mechanically mixing a sulfur-based active material and a solid electrolyte having a diffraction peak A at 2θ=25.6±0.5° and having a diffraction peak B at 2θ=45.2±1.0° in powder X-ray diffraction using CuKα ray to obtain a positive electrode mixture precursor, and heating the positive electrode mixture precursor to obtain a positive electrode mixture, wherein the heating temperature is 160 to 280 °C.

According to the method for producing a positive electrode mixture according to the present aspect, the ionic resistance of the obtained positive electrode mixture can be decreased.

That is, when they are mechanical mixed and then they are heated at the specific temperature of 160 to 280 °C, the solid electrolyte can obtain a characteristic crystallinity which contributes the decrease of the ionic resistance thereof. A new crystalline phase having a slightly different lattice constant is generated in addition to the original crystalline phase, and as a result, such crystallinity can be obtained. In this way, the positive electrode mixture according to an aspect of the present invention described above can be produced.

When the heating temperature is lower than 160 °C, the new crystalline phase is insufficiently generated, and therefore, the ionic resistance thereof is not sufficiently decreased.

When the heating temperature exceeds 280 °C, the original crystalline phase is decomposed, and in addition, an impurity phase (2θ=29°) is generated. As a result, it is unsuitable as the positive electrode mixture.

Examples of the mixing apparatus used in mechanical mixing include, for example, a planetary ball mill, a rolling mill, a bead mill, a FILMIX, a Nauta mixer, a tornado mixer, a twin screw extruder, a multiaxial-spindle roller, a solid-phase-state shear kneader, and the like.

In one embodiment, the heating temperature may be 160 °C or higher, 165 °C or higher, 170 °C or higher, 175 °C or higher, 180 °C or higher, or 185 °C or higher, and it may be 280 °C or lower, 270 °C or lower, 260 °C or lower, 250 °C or lower, 240 °C or lower, 230 °C or lower, 220 °C or lower, 215 °C or lower, 210 °C or lower, 205 °C or lower, 200 °C or lower, or 195 °C or lower.

From the viewpoint of more remarkably decreasing the ionic resistance of the positive electrode mixture, the heating temperature is preferably close to 190 °C among the above-described range.

In the above description of the heating temperature, “X °C or lower” means not to heat at a temperature exceeding X °C.

The heating time is not particularly limited, but they are preferably heated for 30 minutes or more, 60 minutes or more, or 90 minutes or more in the above-described temperature range. The upper limit thereof is not particularly limited, and it is, for example, 20 hours or less, or 10 hours or less.

As the sulfur-based active material, those described for the positive electrode mixture according to an aspect of the present invention can be used.

As the solid electrolyte, the solid electrolyte having the diffraction peak A at 2θ=25.6±0.5° and the diffraction peak B at 2θ=45.2±1.0° in powder X-ray diffraction using CuKα ray is used. As the solid electrolyte, the solid electrolyte containing an argyrodite type crystalline structure described for the positive electrode mixture according to an aspect of the present invention can be given.

The method for producing a solid electrolyte containing an argyrodite type crystalline structure is not particularly limited, and a known method can be used. A raw material mixture is more preferably a combination of lithium sulfide, phosphorus sulfide and lithium halide, and still more preferably a combination of Li₂S, P₂S₅, and LiCl and/or LiBr.

For example, when Li₂S, P₂S₅, LiCl and LiBr are used as a raw material of an argyrodite type solid electrolyte, Li₂S:P₂S₅: the total amount of LiCl and LiBr=30 to 60:10 to 25:15 to 50 can be used as the molar ratio of the input raw material.

The solid electrolyte containing the argyrodite type crystalline structure can be produced by, for example, thoroughly mixing the above-mentioned raw material mixture in a mortar, a ball mill, a vibration mill, a rolling mill, or a kneading machine, and then conducting the heating treatment. Since mixing can be processed continuously in a short time, a kneading machine is preferably used. The kneading machine is not particularly limited, but a multi-axis kneading machine having two or more axis is preferable. In the present mixing, the raw material mixture may be reacted to form glass.

The heating temperature is preferably 350 to 480 °C, more preferably 360 to 460 °C, and particularly preferably 380 to 450 °C.

The heating time is varied depending on the composition and the temperature thereof, but it may be adjusted within a range of, for example, 10 minutes or more and 48 hours or less.

The heating atmosphere is not particularly limited, but it is preferably atmosphere not under hydrogen sulfide airflow but under an inert gas such as nitrogen and argon.

The form of the solid electrolyte is not particularly limited, and examples thereof include a particulate form. The average particle size (D₅₀) of the particulate crystalline sulfide solid electrolyte may be, for example, in the range of 0.01 μm to 500 μm and 0.1 to 200 μm, similar to the average particle size (D₅₀) of the amorphous sulfide solid electrolyte described above.

In one embodiment, the sulfur-based active material to be subjected to mechanical mixing is previously combined with the conductive aid. As the conductive aid, the conductive aid described for the positive electrode mixture according to an aspect of the present invention can be used.

For example, when the sulfur-based active material is heated with the conductive aid prior to mechanical mixing, the sulfur-based active material can be combined with the conductive aid. The heating temperature is not particularly limited, and it is, for example, 120 to 350 °C.

The mass ratio of the sulfur-based active material to the conductive aid (sulfur-based active material: conductive aid) is 10:90 to 95:5, and preferably 30:70 to 90:10.

In one embodiment, the positive electrode mixture produced by the method for producing a positive electrode mixture according to the present aspect is the positive electrode mixture according to an aspect of the present invention described above.

### 3. Lithium-Ion Battery

The lithium-ion battery according to an aspect of the present invention includes the positive electrode mixture according to an aspect of the present invention described above.

According to the lithium-ion battery of the present aspect, since the ionic resistance of the positive electrode mixture can be decreased, the operation with low resistance can be achieved.

The positive electrode mixture can be used as a positive electrode layer of the lithium-ion battery. In this case, a known configuration can be used as other configuration of the lithium-ion battery in the present technical field, and a negative electrode layer in which the negative electrode active material does not contain lithium-ion can be used.

The negative electrode active material included in the negative electrode layer of the lithium-ion battery may be “a negative electrode active material containing lithium-ion”. In addition, the negative electrode active material included in the negative electrode layer of the lithium-ion battery may be “a negative electrode active material that supplies lithium-ion to a positive electrode”.

The negative electrode of the lithium-ion battery is not particularly limited as long as it can be used in ordinary battery. The negative electrode may be formed of a negative electrode mixture obtained by mixing the negative electrode active material and the solid electrolyte.

As the negative electrode active material, commercially available ones can be used. For example, carbon material, Sn metal, In metal, Si metal, alloys of these metals, and the like can be used. Specific examples thereof include natural graphite, various types of graphite, a metal powder such as and Si, Sn, Al, Sb, Zn and Bi, a metal alloy such as SiAl, Sn₅Cu₆, Sn₂Co and Sn₂Fe, others such as an amorphous alloy and a plated alloy. Although there is no particular limitation on the particle size, those having an average particle size of several μm to 80 μm can be suitably used.

The electrolyte layer is not particularly limited, and a known electrolyte layer can be used. For example, an oxide-based solid electrolyte, a sulfide-based solid electrolyte, and a polymer electrolyte is preferable, and a sulfide-based solid electrolyte is more preferable from the viewpoint of ionic conductivity. The sulfide-based solid electrolyte is preferably used for the positive electrode mixture described above.

The method for producing the lithium-ion battery is not particularly limited. For example, a method in which a solid electrolyte layer is formed on a sheet in which the positive electrode layer made of the positive electrode mixture according to an aspect of the present invention is formed on a positive electrode current collector, a sheet having the negative electrode layer formed on a negative electrode current collector in advance is stacked thereon, and then they are pressed, and the like can be given.

### EXAMPLES

Examples of the present invention are described below, but the present invention is not limited by these Examples.

### 1. Production of Positive Electrode Mixture

### Example 1

### (1) Preparation of Composite Powder A

An activated carbon (manufactured by Kansai Coke and Chemicals Company, Limited, MSC-30) and sulfur were added to a glass bottle at a weight ratio of 3:7, and it was added and sealed in a SUS tube container. It was heated in an electric furnace at 150 °C for 6 h, and then 300 °C for 2.75 h to obtain composite powder A of the activated carbon and sulfur.

### (2) Preparation of Solid Electrolyte

0.4129 g of lithium sulfide, 0.5875 g of phosphorus pentasulfide, 0.2241 g of lithium chloride, 0.2755 g of lithium bromide, and ten zirconia balls having the diameter of 10 mm were added to a 45 ml of zirconia pot, and it was sealed. Mixing treatment (mechanical milling) was conducted for 60 hours at a rotational speed of 370 rpm by using a planetary ball mill apparatus (manufactured by Fritsch GmbH, model number P-7) to obtained a powder. The obtained powder was heated at 430 °C for 8 hours to obtain a solid electrolyte A.

### (3) Preparation of Positive Electrode Mixture Powder

0.45 g of the composite powder A and 0.45 g of the solid electrolyte A, together with ten zirconia balls having the diameter of 10 mm, were added to a 45 ml zirconia pot, and it was sealed. Mixing treatment was conducted at room temperature for 20 h at a rotational speed of 370 rpm by using a planetary ball mill apparatus (manufactured by Fritsch GmbH, model number P-7) to obtain composite powder B (positive electrode mixture precursor). The obtained composite powder B was heated at 190 °C for two hours to obtain a positive electrode mixture.

### Example 2

A positive electrode mixture was obtained in the same manner as in Example 1, except that the heating temperature of the composite powder B was 160 °C.

### Example 3

A positive electrode mixture was obtained in the same manner as in Example 1, except that the heating temperature of the composite powder B was 200 °C.

### Example 4

A positive electrode mixture was obtained in the same manner as in Example 1, except that the heating temperature of the composite powder B was 220 °C.

### Comparative Example 1

A positive electrode mixture was obtained in the same manner as in Example 1, except that the composite powder B was not heated.

### Comparative Example 2

A positive electrode mixture was obtained in the same manner as in Example 1, except that the composite powder B was heated at 150 °C for 6 hours, and then it was heated at 300 °C for two hours and 45 minutes.

### 2. Measurement Method and Evaluation Method

### (1) Powder X-Ray Diffraction of Positive Electrode Mixture Powder

The obtained positive electrode mixture powder was measured by XRD measurement.

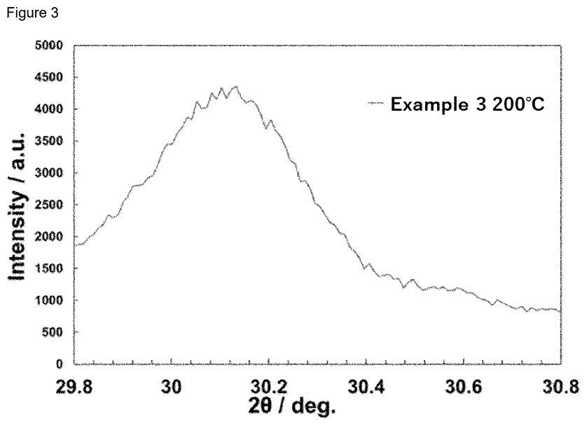

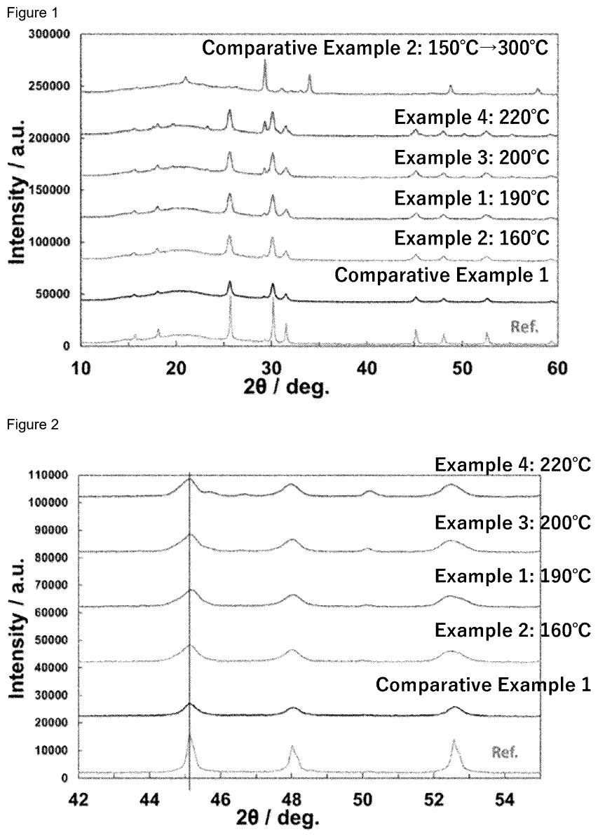

The positive electrode mixture powder of each Examples and Comparative Examples was filled in a trench having the diameter of 20 mm and the depth of 0.2 mm, and then it was leveled by glass to obtain a sample. This sample was sealed with a Kapton film for XRD, and it was measured without exposing to the air. As a reference (“Ref.” in FIGS. 1 and 2), a powder obtained by mortar mixing 0.45 g of each of the solid electrolyte A and composite powder A so that the crystallinity thereof was not compromised was also measured. As a result, peaks derived from an argyrodite type crystalline structure were observed at 2θ=25.6°, 30.2°, 45.2°, and the like in XRD pattern.

The measurement was conducted using a powder X-ray diffractometer D2 PHASER manufactured by Bruker under the following conditions.
Tube voltage: 30 kV
Tube current: 10 mA
X-ray wavelength: Cu-Kα ray (1.5418 angstrom)
Optical system: focusing method
Slit configuration: solar slit 4° (on both incident and receiving sides), divergent slit 1 mm, KB filter (0.5% Ni plate), with air scatter screen 3 mm
Detector: semiconductor detector
Measurement range: 2θ=10 to 60°
Step width, scan speed: 0.05°, 0.05°/sec

For the X-ray diffraction pattern, the presence or absence of each of the diffraction peak A at 2θ=25.6±0.5° and the diffraction peak B at 2θ=45.2±1.0° was determined by the method below. Further, the half width of the diffraction peak A was obtained by the method below.

### Method for Determining Presence or Absence of Each of Diffraction Peak A and Diffraction Peak B Diffraction Peak A

With respect to the presence or absence of the diffraction peak A in the range of 2θ=25.6±0.5°, in the X-ray diffraction pattern, in the case where the mean value of the X-ray intensity (counts) of 2θ=(25.6−0.5)±0.2°, i.e., 2θ=25.1±0.2°, and 2θ=(25.6±0.5)±0.2°, i.e., 2θ=26.1±0.2° was used as the intensity I_{bg} of the background (BG), and where the maximum value of the X-ray intensity (counts) of 2θ=25.1±0.5° was used as the peak intensity Iₚₑₐₖ, when the ratio thereof (Iₚₑₐₖ/I_{bg}) was 1.200 or larger, the presence of the diffraction peak A was determined.

The ratio (Iₚₑₐₖ/I_{bg}) of the diffraction peak A is preferably 1.250 or larger, and more preferably 1.300 or larger.

### Diffraction Peak B

With respect to the presence or absence of the diffraction peak B in the range of 2θ=45.2±1.0°, in the X-ray diffraction pattern, in the case where the mean value of the X-ray intensity (counts) of 2θ=(45.2−1.0)±0.2°, i.e., 2θ=44.2±0.2°, and 2θ=(45.2±1.0)±0.2°, i.e., 2θ=46.2±0.2° was used as the intensity I_{bg} of the background (BG), and where the maximum value of the X-ray intensity (counts) of 2θ=45.2±1.0° was used as the peak intensity Iₚₑₐₖ, when the ratio thereof (Iₚₑₐₖ/I_{bg}) was 1.250 or larger, the presence of the diffraction peak B was determined.

The ratio (Iₚₑₐₖ/I_{bg}) of the diffraction peak B is preferably 1.300 or larger, and more preferably 1.350 or larger.

As the results of the above, in the positive electrode mixture of Examples 1 to 4 and Comparative Example 1, since each ratio (Iₚₑₐₖ/I_{bg}) was 2.578, 2.629, 2.704, 2.838 and 2.311, the diffraction peak A was determined to be “present”, and since each ratio (Iₚₑₐₖ/I_{bg}) was 3.287, 3.232, 3.370, 3.370 and 2.688, the diffraction peak B was determined to be “present”.

On the other hand, in the positive electrode mixture of Comparative Example 2, since the ratio (Iₚₑₐₖ/I_{bg}) was 1.108, the diffraction peak A was determined to be “absent”, and since the ratio (Iₚₑₐₖ/I_{bg}) was 1.198, the diffraction peak B was determined to be “absent”.

### Calculation of Half Width

The half width B in which the apparatus constant was subtracted therefrom was calculated from β=w−B.
w: half width of the peak of 25.6±0.5° (diffraction peak A) obtained by measurement
B: the apparatus constant (standard substance (silicon) was measured in the same manner, and
B=0.1269° was obtained from the peak of) 2θ=28.4°)

The value w (the half width obtained by measurement) was obtained as follows. A baseline using a straight line for the peak-shape obtained by XRD measurement was set, and the difference between the intensity and the baseline at each point was obtained to form the XRD curve. The XRD curve was used as the formula (f(x)=(1−α)×L(x)+α×G(x)) composed of Lorentz function L(x) and Gaussian function G(x) to determine parameter A (corrected peak intensity), w, x₀ (2θ of peak top) and α (proportion of Lorentz function) by curve fitting.

$$L ( x ) = A \frac{{w}^{2}}{4 {( x - {x}_{0} )}^{2} + {w}^{2}}$$

$$G ( x ) = A exp ( - 4 ln 2 \frac{{( x - {x}_{0} )}^{2}}{{w}^{2}} )$$

In the curve fitting, a range of about ±1.0° from the peak top was suitably set as the fitting range. The error between the intensity of the fitting curve calculated by f(x) at θ and the intensity of XRD curve were obtained, and the total amount of the errors across the fitting range was minimized to conduct Fitting. The solver function (GRG nonlinear) of spreadsheet software (Excel, Microsoft) was used here.

### Left-Right Asymmetry Parameter ε′

The same manner as in “(3) Calculation of half width of powder X-ray diffraction” was conducted on the peak at 2θ=45.2±1.0° (diffraction peak B) to obtain XRD curve subjected to baseline correction and the fitting curve f(x)) (44.38°≤θ≤46.05°. The curve f(x) was a symmetric curve fitted so as to minimize the total amount of errors & with respect to XRD curve, that is, squares of the intensity differences at each 0. When the error rate E′ was defined as shown in the following formula in the case, it can be said that the larger E′ of the peak was, the larger the error in the case where fitting was conducted on the symmetrical curve, that is, the higher the left-right asymmetry of the peak.

ε′=total amount of errors/number of elements (number of plots in 44.38°≤θ≤46.05°)

### (2) Evaluation of Ionic Resistance

### Preparation of Solid Electrolyte

0.4127 g of lithium sulfide, 0.6655 g of phosphorus pentasulfide, 0.2137 g of lithium iodide, 0.2080 g of lithium bromide, and ten zirconia balls having the diameter of 10 mm were added to a 45 ml of zirconia pot, and it was sealed. Mixing treatment (mechanical milling) was conducted for 40 hours at a rotational speed of 370 rpm by using a planetary ball mill apparatus (manufactured by Fritsch GmbH, model number P-7) to obtained a powder. The obtained powder was heated at 195 °C for three hours to obtain a solid electrolyte B.

### Production of Cell for Ionic Resistance Measurement

100 mg of the solid electrolyte B prepared using the above-described manner was pressure molded in a Macor cylinder having the diameter of 10 mm. 20 mg of the positive electrode mixture powder was added on the pressure surface thereof, and it was molded with pressure again. 20 mg of the positive electrode mixture powder was added on the pressure surface opposite to the positive electrode mixture, and it was pressurized to produce a cell for ionic resistance measurement.

### Ionic Resistance Measurement

AC impedance measurement was conducted under the following conditions using the cell for ionic resistance measurement produced by the above manner.
Frequency-range: 1 MHz to 1 mHz
Amplitude: 10 mV

Table 1 shows the half width of the diffraction peak A, the left-right asymmetry parameter ε′ of the diffraction peak B, and the ionic resistance for each mixture. In addition, FIG. 1 shows a XRD spectrum, and FIG. 2 shows an enlarged view of the high-angle-side in XRD spectrum.

TABLE 1

| | Heating | | | Ionic |
|---|---|---|---|---|
| | temperature | Half width | Parameter ε′ | resistance |
| | [°C] | [°] | [—] | [Ωcm] |
| Example 1 | 190 | 0.33 | 5.80 × 10⁴ | 155 |
| Example 2 | 160 | 0.29 | 3.23 × 10⁴ | 253 |
| Example 3 | 200 | 0.31 | 4.48 × 10⁴ | 174 |
| Example 4 | 220 | 0.27 | 8.99 × 10⁴ | 219 |
| Comparative | It was | 0.21 | 1.20 × 10⁴ | 860 |
| Example 1 | not heated | | | |
| Comparative | 150 → 300 | Solid | Solid | Not measurable |
| Example 2 | | electrolyte | electrolyte | (measurement |
| | | was | was | limit was |
| | | decomposed | decomposed | exceeded) |

### 3. Evaluation

As can be seen from Table 1, it was found that the positive electrode mixture of Examples 1 to 4 exhibited larger half width of the diffraction peak A and larger left-right asymmetry parameter ε′ of the diffraction peak B, and lower ionic resistance as compared to those in Comparative Example 1.

As can be seen from FIG. 1, it was found that the crystallinity of the solid electrolyte was decreased by mechanical mixing (for example, since that of Ref. which was not mechanically mixed was compared with that of Comparative Example 1 which was mechanically mixed). In contrast, it can be confirmed that those of Examples 1 to 4 which were mechanically mixed, and then were heated at 160 to 220 °C showed peaks at the same positions as that of Ref. to confirm crystallinity. On the other hand, that of Comparative Example 2 which was heated to 300 °C showed smaller peaks at the same positions as that of Ref., and therefore, it is considered that the solid electrolyte was decomposed (instead, generation of an impurity phase) (2θ=29° can be confirmed).

Those of Examples 1 to 4 exhibited larger half width of the diffraction peak A, and the diffraction peak B was left-right asymmetric (the left-right asymmetry parameter ε′ is large) as shown in FIG. 2, so that it is considered that a new crystalline phase having a slightly different lattice constant was generated in the solid electrolyte in addition to the original crystalline phase (the differences in such a slightly different lattice constant and in the peak position in XRD spectrum were remarkable at the high-angle side shown in FIG. 2). It is considered that such a feature contributed to the decrease in ionic resistance.

FIG. 3 shows the results of XRD measurement of the positive electrode mixture obtained in Example 3 under the same conditions as in Patent Document 3. As can be seen from FIG. 3, it was found that the behavior (manner of splitting) of the crystalline peak of the positive electrode mixture obtained in Example 3 was clearly different from that of the positive electrode mixture described in Patent Document 3 (see XRD spectrum of FIG. 1 described in Patent Document 3) to obtain different crystalline phase (it is considered that the other Examples exhibited the same as those thereof).

### INDUSTRIAL APPLICABILITY

The positive electrode mixture of the present invention is suitable as the positive electrode of the lithium-ion battery. In addition, the lithium-ion battery of the present invention is suitably used for, for example, a battery and the like used in an information-related device and a communication device such as a personal computer, a video camera and a mobile phone, a vehicle such as an electric vehicle.

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

The documents described in the specification and the specification of Japanese application(s) on the basis of which the present application claims Paris convention priority are incorporated herein by reference in its entirety.

1. A positive electrode mixture comprising a sulfur-based active material and a solid electrolyte,
wherein in the powder X-ray diffraction using CuKα ray, the positive electrode mixture has a diffraction peak A at 2θ=25.6±0.5° and a diffraction peak B at 2θ=45.2±1.0°, and
it has a half width of the diffraction peak A of 0.25° or larger.

2. The positive electrode mixture according to claim 1, wherein a left-right asymmetry parameter ε′ of the diffraction peak B is 1.50×10⁴ or more.

3. The positive electrode mixture according to claim 1, which further comprises a conductive aid.

4. The positive electrode mixture according to claim 3, wherein the conductive aid has a pore having a pore diameter of smaller than 5 nm.

5. The positive electrode mixture according to claim 3, wherein the conductive aid comprises one or more members selected from the group consisting of activated carbon and carbon black.

6. The positive electrode mixture according to claim 1, which is obtained by heating treatment of a positive electrode mixture precursor obtained by mechanically mixing the sulfur-based active material and a solid electrolyte having the diffraction peak A at 2θ=25.6±0.5° and having the diffraction peak B at 2θ=45.2±1.0° in powder X-ray diffraction using CuKα ray.

7. The positive electrode mixture according to claim 6, wherein a temperature of the heating treatment is 160 to 280 °C.

8. A method for producing a positive electrode mixture, comprising:
mechanically mixing a sulfur-based active material and a solid electrolyte having a diffraction peak A at 2θ=25.6±0.5° and having a diffraction peak B at 2θ=45.2±1.0° in powder X-ray diffraction using CuKα ray to obtain a positive electrode mixture precursor, and
heating the positive electrode mixture precursor to obtain a positive electrode mixture,
wherein the heating temperature is 160 to 280 °C.

9. A lithium-ion battery comprising the positive electrode mixture according to claim 1.
